(19) United States
(12) Patent Application Publication
(10) Pub. No.: US 2021/0014572 A1
(43) Pub. Date: Jan. 14, 2021

(54) DISPLAY DEVICE

(71) Applicant: LG ELECTRONICS INC., Seoul (KR)

(72) Inventors: Younkyung LEE, Seoul (KR); Jinyung PARK, Seoul (KR); Jeehoon BONG, Seoul (KR); Seunghyun LEE, Seoul (KR); Sanghyuck LEE, Seoul (KR); Chulbae LEE, Seoul (KR)

(73) Assignee: LG ELECTRONICS INC., Seoul (KR)

(21) Appl. No.: 16/977,804

(22) PCT Filed: Mar. 9, 2018
(86) PCT No.: PCT/KR2018/002838

§ 371 Date: Sep. 2, 2020

(51) Int. Cl. H04N 21/472; H04N 21/231; H04N 21/239; H04N 21/2385; H04N 21/482; H04N 21/438; H04N 21/234

(52) U.S. Cl. CPC H04N 21/47214; H04N 21/231; H04N 21/2393; H04N 21/234; H04N 21/4821; H04N 21/4383; H04N 21/2385

(57) ABSTRACT

A display device according to an embodiment of the present invention may comprise: a storage unit; a display unit; a network interface unit for performing a communication with a server of a content provider providing a content; and a control unit for generating a virtual channel number upon receipt of a virtual channel generation request for the content, and matching the generated virtual channel number to an access address of the content so as to store in the storage unit.

### TECHNICAL FIELD

The present disclosure relates to a display device.

### BACKGROUND ART

Digital TV services using wired or wireless communication networks are becoming common. Digital TV service may provide a variety of services that could not be provided in the conventional analog broadcasting service.

For example, IPTV (Internet Protocol Television), which is a type of digital TV service, and smart TV service provide bidirectionality that allows a user to actively select a type of viewing the program and viewing time. IPTV, smart TV service may provide a variety of additional services, such as Internet search, home shopping, and online games based on this bidirectionality.

### DISCLOSURE

### Technical Problem

An object of the present disclosure is to provide a display device enabling a user to freely generate a channel for himself/herself.

### Technical Solution

According to an embodiment of the present disclosure, the display device may include a storage unit, a display unit, a network interface unit to make communication with a server of a content provider to provide content, and a control unit to generate a virtual channel number in response to receiving a virtual channel generating request for the content, match the generated virtual channel number with an access address of the content, and store a matching result in the storage unit.

### Advantageous Effects

According to various embodiments of the present disclosure, since a user may easily access a content video of interest through a virtual channel generated by the user, user experience may be improved.

### DESCRIPTION OF DRAWINGS

FIG. 1 is a block diagram illustrating a configuration of a display device according to an embodiment of the present disclosure.

FIG. 2 is a block diagram illustrating a remote control device according to an embodiment of the present disclosure.

FIG. 3 is a view illustrating an actual configuration of a remote control device according to an embodiment of the present disclosure.

FIG. 4 is a view of utilizing a remote control device according to an embodiment of the present disclosure.

FIG. 5 is a flowchart illustrating a method for operating a display device according to an exemplary embodiment of the present disclosure.

FIGS. 6A and 6B illustrate a process of generating a content item, to which a user subscribes, with a virtual channel according to an embodiment of the present disclosure.

FIG. 7A to 7C illustrate a procedure of generating a content item found by a user through a virtual channel according to an embodiment of the present disclosure.

FIGS. 8A to 8C illustrate a viewing reservation function for content provided through a virtual channel according to an embodiment of the present disclosure.

FIG. 9 illustrates a channel table according to an embodiment of the present disclosure.

FIG. 10 illustrates information on a virtual channel which is included in an electronic program guide according to an embodiment of the present invention.

### BEST MODE

### Mode for Invention

Hereinafter, embodiments relating to the present disclosure will be described in detail with reference to the accompanying drawings. The suffixes “module” and “unit” for components used in the description below are assigned or mixed in consideration of easiness in writing the specification and do not have distinctive meanings or roles by themselves.

A display device according to an embodiment of the present disclosure, for example, as an artificial display device that adds a computer supporting function to a broadcast receiving function, may have an easy-to-use interface such as a writing input device, a touch screen, or a spatial remote control device as an Internet function is added while fulfilling the broadcast receiving function. Then, with the support of a wired or wireless Internet function, it is possible to perform an e-mail, web browsing, banking, or game function in access to Internet and computers. In order to perform such various functions, standardized general purpose OS may be used.

Accordingly, since various applications are freely added or deleted on a general purpose OS kernel, a display device described herein, for example, may perform various user-friendly functions. The display device, in more detail, may be a network TV, Hybrid Broadcast Broadband TV (HBBTV), smart TV, light-emitting diode (LED) TV, organic light-emitting diode (OLED) TV, and so on and in some cases, may be applied to a smartphone.

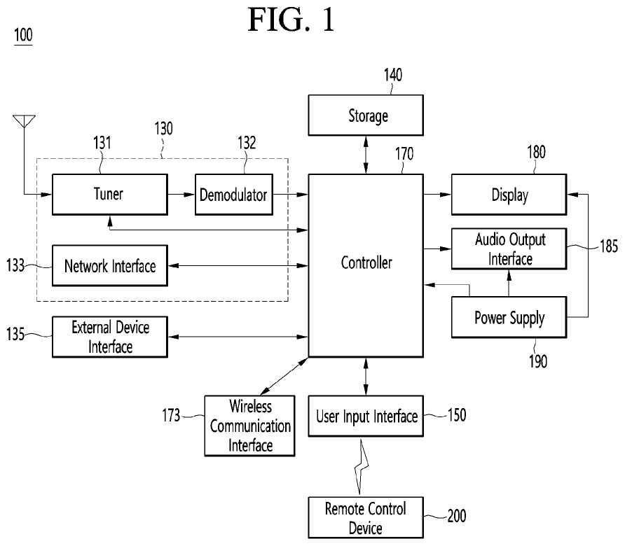

FIG. 1 is a block diagram illustrating a configuration of a display device according to an embodiment of the present disclosure.

Referring to FIG. 1, a display device 100 may include a broadcast reception unit 130, an external device interface unit 135, a storage unit 140, a user interface unit 150, a control unit 170, a wireless communication unit 173, a display unit 180, an audio output unit 185, and a power supply unit 190.

The broadcast reception unit 130 may include a tuner 131, a demodulation unit 132, and a network interface unit 133.

The tuner 131 may select a specific broadcast channel according to a channel selection command. The tuner 131 may receive broadcast signals for the selected specific broadcast channel.

The demodulation unit 132 may divide the received broadcast signals into video signals, audio signals, and broadcast program related data signals and restore the divided video signals, audio signals, and data signals to an output available form.

The external device interface unit 135 may receive an application or an application list in an adjacent external device and deliver it to the control unit 170 or the storage unit 140.

The external device interface unit 135 may provide a connection path between the display device 100 and an external device. The external device interface unit 135 may receive at least one an image or audio output from an external device that is wirelessly or wiredly connected to the display device 100 and deliver it to the control unit 170. The external device interface unit 135 may include a plurality of external input terminals. The plurality of external input terminals may include an RGB terminal, at least one High Definition Multimedia Interface (HDMI) terminal, and a component terminal.

An image signal of an external device input through the external device interface unit 135 may be output through the display unit 180. A voice signal of an external device input through the external device interface unit 135 may be output through the audio output unit 185.

An external device connectable to the external device interface unit 135 may be one of a set-top box, a Blu-ray player, a DVD player, a game console, a sound bar, a smartphone, a PC, a USB Memory, and a home theater system, but this is just exemplary.

The network interface unit 133 may provide an interface for connecting the display device 100 to a wired/wireless network including the Internet network. The network interface unit 133 may transmit or receive data to or from another user or another electronic device through an accessed network or another network linked to the accessed network.

Additionally, some content data stored in the display device 100 may be transmitted to a user or an electronic device, which is selected from other users or other electronic devices pre-registered in the display device 100.

The network interface unit 133 may access a predetermined webpage through an accessed network or another network linked to the accessed network. In other words, the network interface unit 133 may transmit or receive data to or from a corresponding server by accessing a predetermined webpage through the network.

Then, the network interface unit 133 may receive contents or data provided from a content provider or a network operator. In other words, the network interface unit 133 may receive contents such as movies, advertisements, games, VODs, and broadcast signals, which are provided from a content provider or a network provider, through network and information relating thereto.

Additionally, the network interface unit 133 may receive firmware update information and update files provided from a network operator and transmit data to an Internet or content provider or a network operator.

The network interface unit 133 may select and receive a desired application among applications open to the air, through network.

The storage unit 140 may store signal-processed image, voice, or data signals stored by a program in order for each signal processing and control in the control unit 170.

Additionally, the storage unit 140 may perform a function for temporarily storing image, voice, or data signals output from the external device interface unit 135 or the network interface unit 133 and may store information on a predetermined image through a channel memory function.

The storage unit 140 may store an application or an application list input from the external device interface unit 135 or the network interface unit 133.

The display device 100 may play content files (for example, video files, still image files, music files, document files, application files, and so on) stored in the storage unit 140 and provide them to a user.

The user interface unit 150 may deliver signals input by a user to the control unit 170 or deliver signals from the control unit 170 to a user. For example, the user interface unit 150 may receive or process control signals such as power on/off, channel selection, and screen setting from the remote control device 200 or transmit control signals from the control unit 170 to the remote control device 200 according to various communication methods such as Bluetooth, Ultra Wideband (WB), ZigBee, Radio Frequency (RF), and IR.

Additionally, the user interface unit 150 may deliver, to the control unit 170, control signals input from local keys (not illustrated) such as a power key, a channel key, a volume key, and a setting key.

Image signals that are image-processed in the control unit 170 may be input to the display unit 180 and displayed as an image corresponding to corresponding image signals. Additionally, image signals that are image-processed in the control unit 170 may be input to an external output device through the external device interface unit 135.

Voice signals processed in the control unit 170 may be output to the audio output unit 185. Additionally, voice signals processed in the control unit 170 may be input to an external output device through the external device interface unit 135.

Besides that, the control unit 170 may control overall operations in the display device 100.

Additionally, the control unit 170 may control the display device 100 by a user command or internal program input through the user interface unit 150 and download a desired application or application list into the display device 100 in access to network.

The control unit 170 may output channel information selected by a user together with processed image or voice signals through the display unit 180 or the audio output unit 185.

Additionally, according to an external device image playback command received through the user interface unit 150, the control unit 170 may output image signals or voice signals of an external device such as a camera or a camcorder, which are input through the external device interface unit 135, through the display unit 180 or the audio output unit 185.

Moreover, the control unit 170 may control the display unit 180 to display images and control broadcast images input through the tuner 131, external input images input through the external device interface unit 135, images input through the network interface unit, or images stored in the storage unit 140 to be displayed on the display unit 180. In this case, an image displayed on the display unit 180 may be a still image or video and also may be a 2D image or a 3D image.

Additionally, the control unit 170 may play content stored in the display device 100, received broadcast content, and external input content input from the outside, and the content may be in various formats such as broadcast images, external input images, audio files, still images, accessed web screens, and document files.

The wireless communication unit 173 may perform a wired or wireless communication with an external electronic device. The wireless communication unit 173 may perform short-range communication with an external device. For this, the wireless communication unit 173 may support short-range communication by using at least one of Bluetooth'TM, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication unit 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication unit 173 may detect (or recognize) a communicable wearable device around the display device 100. Furthermore, if the detected wearable device is a device authenticated to communicate with the display device 100, the control unit 170 may transmit at least part of data processed in the display device 100 to the wearable device through the wireless communication unit 173. Accordingly, a user of the wearable device may use the data processed in the display device 100 through the wearable device.

The display unit 180 may convert image signals, data signals, or on-screen display (OSD) signals, which are processed in the control unit 170, or images signals or data signals, which are received in the external device interface unit 135, into R, G, and B signals to generate driving signals.

Meanwhile, the display device 100 illustrated in FIG. 1 is just one embodiment of the present disclosure and thus, some of the components illustrated may be integrated, added, or omitted according to the specification of the actually implemented display device 100.

In other words, if necessary, two or more components may be integrated into one component or one component may be divided into two or more components and configured. Additionally, a function performed by each block is to describe an embodiment of the present disclosure and its specific operation or device does not limit the scope of the present disclosure.

According to another embodiment of the present disclosure, unlike FIG. 1, the display device 100 may receive images through the network interface unit 133 or the external device interface unit 135 and play them without including the tuner 131 and the demodulation unit 132.

For example, the display device 100 may be divided into an image processing device such as a set-top box for receiving broadcast signals or contents according to various network services and a content playback device for playing contents input from the image processing device.

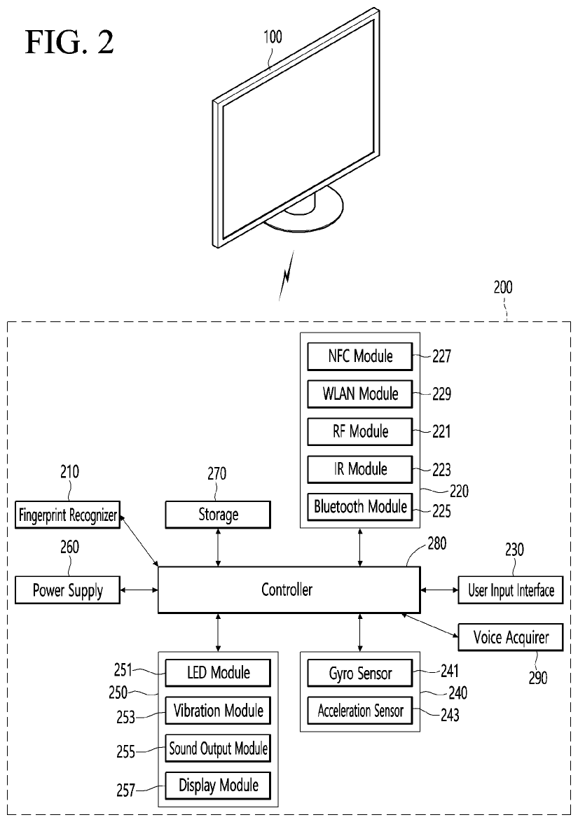

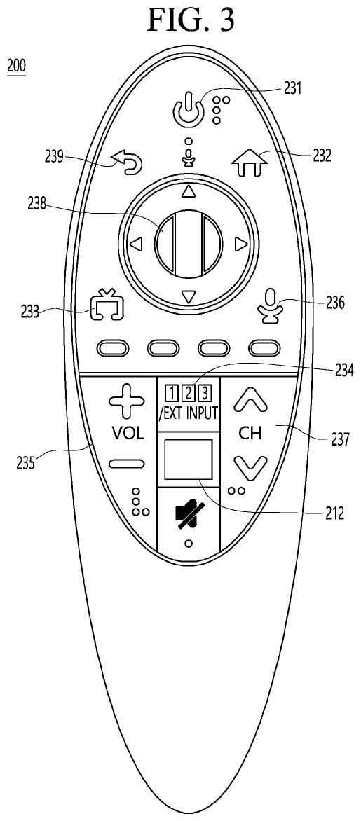

In this case, an operating method of a display device according to an embodiment of the present disclosure described below may be performed by one of the display device described with reference to FIG. 1, an image processing device such as the separated set-top box, and a content playback device including the display unit 180 and the audio output unit 185. p Then, referring to FIGS. 2 and 3, a remote control device is described according to an embodiment of the present disclosure.

FIG. 2 is a block diagram illustrating a remote control device according to an embodiment of the present disclosure and FIG. 3 is a view illustrating an actual configuration of a remote control device 200 according to an embodiment of the present disclosure.

First, referring to FIG. 2, a remote control device 200 may include a fingerprint recognition unit 210, a wireless communication unit 220, a user input unit 230, a sensor unit 240, an output unit 250, a power supply unit 260, a storage unit 270, a control unit 280, and a voice acquisition unit 290.

Referring to FIG. 2, the wireless communication unit 220 transmits/receives signals to/from an arbitrary any one of display devices according to the above-mentioned embodiments of the present disclosure.

The remote control device 200 may include a radio frequency (RF) module 221 for transmitting/receiving signals to/from the display device 100 according to the RF communication standards and an IR module 223 for transmitting/receiving signals to/from the display device 100 according to the IR communication standards. Additionally, the remote control device 200 may include a Bluetooth module 225 for transmitting/receiving signals to/from the display device 100 according to the Bluetooth communication standards. Additionally, the remote control device 200 may include a Near Field Communication (NFC) module 227 for transmitting/receiving signals to/from the display device 100 according to the NFC communication standards and a WLAN module 229 for transmitting/receiving signals to/from the display device 100 according to the Wireless LAN (WLAN) communication standards.

Additionally, the remote control device 200 may transmit signals containing information on a movement of the remote control device 200 to the display device 100 through the wireless communication unit 220.

Moreover, the remote control device 200 may receive signals transmitted from the display device 100 through the RF module 221 and if necessary, may transmit a command on power on/off, channel change, and volume change to the display device 100 through the IR module 223.

The user input unit 230 may be configured with a keypad button, a touch pad, or a touch screen. A user may manipulate the user input unit 230 to input a command relating to the display device 100 to the remote control device 200. If the user input unit 230 includes a hard key button, a user may input a command relating to the display device 100 to the remote control device 200 through the push operation of the hard key button. This will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a voice adjustment button 235, a voice recognition button 236, a channel change button 237, a check button 238, and a back button 239.

The fingerprint recognition button 212 may be a button for recognizing a user's fingerprint. According to an embodiment of the present disclosure, the fingerprint recognition button 212 may perform a push operation and receive a push operation and a fingerprint recognition operation. The power button 231 may be button for turning on/off the power of the display device 100. The home button 232 may be a button for moving to the home screen of the display device 100. The live button 233 may be a button for displaying live broadcast programs. The external input button 234 may be a button for receiving an external input connected to the display device 100. The voice adjustment button 235 may be a button for adjusting the size of a volume output from the display device 100. The voice recognition button 236 may be a button for receiving user's voice and recognizing the received voice. The channel change button 237 may be a button for receiving broadcast signals of a specific broadcast channel. The check button 238 may be a button for selecting a specific function and the back button 239 may be a button for returning to a previous screen.

FIG. 2 will be described again.

If the user input unit 230 includes a touch screen, a user may touch a soft key of the touch screen to input a command relating to the display device 100 to the remote control device 200. Additionally, the user input unit 230 may include various kinds of input means manipulated by a user, for example, a scroll key and a jog key, and this embodiment does not limit the scope of the present disclosure.

The sensor unit 240 may include a gyro sensor 241 or an acceleration sensor 243 and the gyro sensor 241 may sense information on a movement of the remote control device 200.

For example, the gyro sensor 241 may sense information on an operation of the remote control device 200 on the basis of x, y, and z axes and the acceleration sensor 243 may sense information on a movement speed of the remote control device 200. Moreover, the remote control device 200 may further include a distance measurement sensor and sense a distance with respect to the display unit 180 of the display device 100.

The output unit 250 may output image or voice signals corresponding to manipulation of the user input unit 235 or corresponding to signals transmitted from the display device 100. A user may recognize whether the user input unit 235 is manipulated or the display device 100 is controlled through the output unit 250.

For example, the output unit 250 may include an LED module 251 for flashing, a vibration module 253 for generating vibration, a sound output module 255 for outputting sound, or a display module 257 for outputting an image, if the user input unit 235 is manipulated or signals are transmitted/received to/from the display device 100 through the wireless communication unit 225.

Additionally, the power supply unit 260 supplies power to the remote control device 200 and if the remote control device 200 does not move for a predetermined time, stops the power supply, so that power waste may be reduced. The power supply unit 260 may resume the power supply if a predetermined key provided at the remote control device 200 is manipulated.

The storage unit 270 may store various kinds of programs and application data necessary for control or operation of the remote control device 200. If the remote control device 200 transmits/receives signals wirelessly through the display device 100 and the RF module 221, the remote control device 200 and the display device 100 transmits/receives signals through a predetermined frequency band.

The control unit 280 of the remote control device 200 may store, in the storage unit 270, information on a frequency band for transmitting/receiving signals to/from the display device 100 paired with the remote control device 200 and refer to it.

The control unit 280 controls general matters relating to control of the remote control device 200. The control unit 280 may transmit a signal corresponding to a predetermined key manipulation of the user input unit 235 or a signal corresponding to movement of the remote control device 200 sensed by the sensor unit 240 to the display device 100 through the wireless communication unit 225.

Additionally, the voice acquisition unit 290 of the remote control device 200 may obtain voice.

The voice acquisition unit 290 may include at least one microphone 291 and obtain voice through the microphone 291.

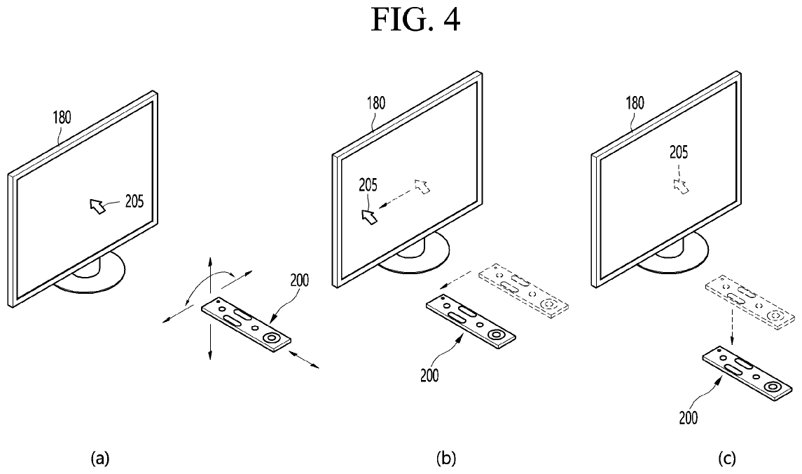

Next, FIG. 4 is illustrated.

FIG. 4 is a view of utilizing a remote control device according to an embodiment of the present disclosure.

FIG. 4A illustrates that a pointer 205 corresponding to the remote control device 200 is displayed on the display unit 180.

A user may move or rotate the remote control device 200 vertically or horizontally. The pointer 205 displayed on the display unit 180 of the display device 100 corresponds to a movement of the remote control device 200. Since the corresponding pointer 205 is moved and displayed according to a movement on a 3D space as show in the drawing, the remote control device 200 may be referred to as a spatial remote control device.

FIG. 4B illustrates that if a user moves the remote control device 200, the pointer 205 displayed on the display unit 180 of the display device 100 is moved to the left according to the movement of the remote control device 200.

Information on a movement of the remote control device 200 detected through a sensor of the remote control device 200 is transmitted to the display device 100. The display device 100 may calculate the coordinates of the pointer 205 from the information on the movement of the remote control device 200. The display device 100 may display the pointer 205 to match the calculated coordinates.

FIG. 4C illustrates that while a specific button in the remote control device 200 is pressed, a user moves the remote control device 200 away from the display unit 180. Thus, a selection area in the display unit 180 corresponding to the pointer 205 may be zoomed in and displayed larger.

On the contrary, if the user moves the remote control device 200 to approach the display unit 180, the selection area in the display unit 180 corresponding to the pointer 205 may be zoomed out and reduced.

On the other hand, if the remote control device 200 is moved away from the display unit 180, a selection area may be zoomed out and if the remote control device 200 is moved closer to the display unit 180, a selection area may be zoomed in.

Additionally, if a specific button in the remote control device 200 is pressed, recognition of a vertical or horizontal movement may be excluded. In other words, if the remote control device 200 is moved away from or closer to the display unit 180, the up, down, left, or right movement cannot be recognized and only the back and forth movement may be recognized. While a specific button in the remote control device 200 is not pressed, only the pointer 205 is moved according to the up, down, left or right movement of the remote control device 200.

Moreover, the moving speed or moving direction of the pointer 205 may correspond to the moving speed or moving direction of the remote control device 200.

Furthermore, a pointer in this specification means an object displayed on the display unit 180 in response to an operation of the remote control device 200. Accordingly, besides an arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display unit 180 and also may be displayed in correspondence to a plurality of points such as a line and a surface.

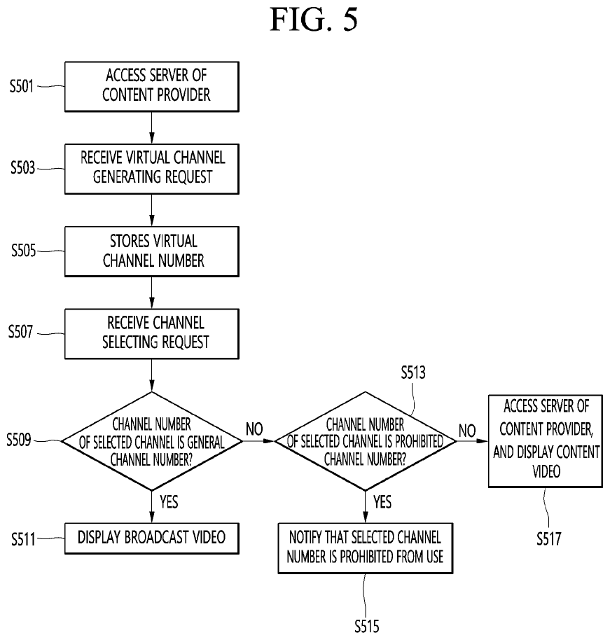

Hereinafter, a method for operating a system according to an embodiment of the present disclosure will be described with reference to FIG. 5.

FIG. 5 is a flowchart illustrating a method for operating a display device according to an exemplary embodiment of the present disclosure.

Referring to FIG. 5, the control unit 170 of the display device 100 accesses a server of a content provider through the network interface unit 133 (S501).

The control unit 170 may access the server of the content provider and receive content such as a movie, an advertisement, a game, a VOD, and relevant information thereto which are provided from the content provider.

In addition, the control unit 170 may display the content and relevant information thereto, which are received from the content provider, on the display unit 180.

In another embodiment, the control unit 170 may access the server of the content provider using a set top box connected through the external device interface unit 135.

The control unit 170 may receive a virtual channel generating request to view the content provided from the content provider (S503).

According to an embodiment, the control unit 170 may receive a virtual channel generating request for generating a virtual channel from the remote control device 200.

The virtual channel may be a channel that may be virtually generated instead of a channel provided by the display device 100 or a channel provided by the set top box connected to the display device 100.

In detail, the control unit 170 may receive a virtual channel generating request from the wireless communication unit 220 of the remote control device 200 through the user input interface unit 150.

The virtual channel generating request may be a request for selecting a channel generating button included in the display unit 180 by the pointer 205. The details thereof will be described later.

The control unit 170 generates a virtual channel number corresponding to an access address of the relevant content, in response to the virtual channel generating request, and stores the generated virtual channel number in the storage unit 140 (S505).

According to an embodiment, when the virtual channel generating request is received, the control unit 170 may obtain an access address of the content displayed on the display unit 180 or an access address of the content item.

The access address may be a URL.

According to an embodiment, the control unit 170 may generate a virtual channel number corresponding to the obtained access address of a web-site in response to the virtual channel generating request. The virtual channel number may be any channel number that is not prohibited from use.

The control unit 170 may match the access address of the web site with the corresponding virtual channel number and store the matching result in the storage unit 140.

Thereafter, the control unit 170 receives a channel selecting request (S507).

In an embodiment, the control unit 170 may receive a channel selecting request from the remote control device 200. The user may select a specific channel through a channel up button, a channel down button, and a numeric button of the remote control device 200.

The control unit 170 determines whether the channel number of the selected channel is a general channel number in response the received channel selecting request (S509).

The channel number may be any one of a general channel number, a prohibited channel number, and a virtual channel number.

The general channel number may be a channel number provided through the set top box connected to the display device 100.

The prohibited channel number may be a channel number that is prohibited from use by a vendor of the set top box or for other reasons.

The virtual channel number may be a channel number that may be virtually generated in response to the request of the user. The virtual channel number may be deleted in response to the request of the user.

According to an embodiment, the control unit 170 may determine whether a program identifier corresponding to the selected channel number is stored. The program identifier may be an identifier for identifying a broadcast program provided from the tuner 131 or the set top box.

One broadcast program may correspond to one program identifier. In addition, the program identifier may correspond to the general channel number.

The program identifier may be included in electronic program guide (EPG) information stored in the storage unit 140.

The control unit 170 may determine whether a program identifier corresponding to the selected channel number is stored in the EPS information.

When the program identifier corresponding to the selected channel number is found in the EPG information, the control unit 170 may recognize the selected channel number as the general channel number.

The control unit 170 displays, on the display unit 180, a broadcast video corresponding to the channel number received from the tuner 131 or the set top box, when the channel number of the selected channel is the general channel number (S511).

The control unit 170 determines whether the corresponding channel number is the prohibited channel number, when the channel number of the selected channel is not the general channel number (S513).

When the program identifier corresponding to the channel number of the selected channel is not found, and belongs to a preset prohibited channel number group, the control unit 170 may recognize the corresponding channel number as the prohibited channel number.

The control unit 170 notifies that the selected channel number is prohibited from use when the selected channel number is the prohibited channel (S515).

In an embodiment, when the selected channel number is the prohibited channel number, the control unit 170 may display a black screen on the display unit 180.

According to another embodiment, when the selected channel number is the prohibited channel number, the control unit 170 may display a pop-up window indicating that the channel is prohibited from use, on the display unit 180.

When the channel number is not the prohibited channel number, the control unit 170 recognizes the channel number as a virtual channel number, access the server of the content provider, and displays the content video on the display unit 180 (S517).

When the access address corresponding to the selected channel number is found in the storage unit 140, the control unit 170 may recognize the selected channel number as the virtual channel number.

The control unit 170 may access the server of the content provider using the access address corresponding to the virtual channel number. The control unit 170 may reproduce the content video, which is provided from the server of the connected content provider, on the display unit 180.

Hereinafter, an embodiment illustrated in FIG. 5 will be described in detail.

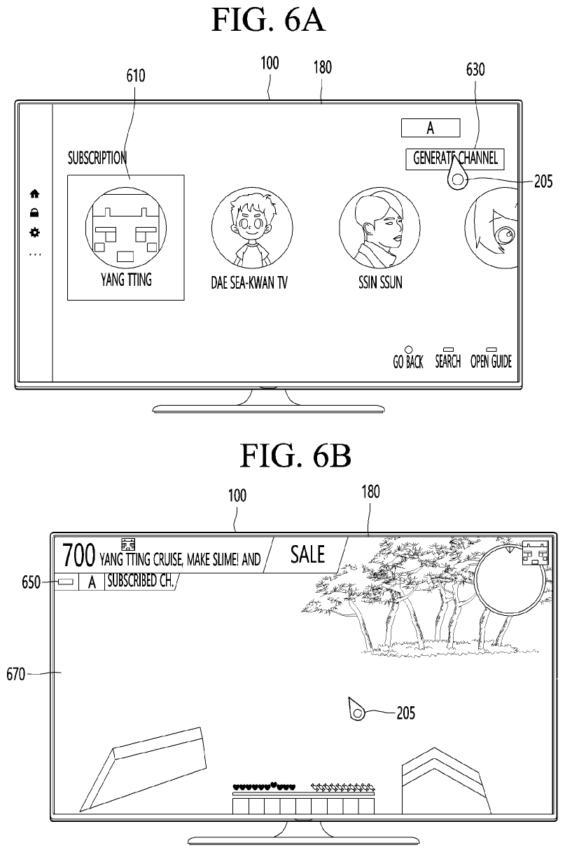

FIGS. 6A and 6B illustrate a process of generating a content item, to which a user subscribes, with a virtual channel according to an embodiment of the present disclosure.

Referring to FIG. 6A, the display unit 180 displays a screen connected to a server of a content provider A.

In particular, the display unit 180 displays a plurality of content items to which the user subscribes. Each content item may be an item for identifying another person who performs personal broadcasting.

In addition, the display unit 180 may further display a virtual channel generating button 630.

When any one content item 610 of the plurality of content items is selected, and when a request for selecting a virtual channel generating button 630 is received, the control unit 170 may generate a virtual channel for the selected content item 610. Simultaneously, the control unit 170 may assign a virtual channel number (#700) to the content item 610, match the assigned virtual channel number with an access address of the content item 610, and store the matching result in the storage unit 140.

The content item 610 and the virtual channel generating button 630 may be selected through the pointer 205 moving under the control of the remote control device 200.

The control unit 170 may access the access address matched with the virtual channel number (#700) in response to the request for selecting the virtual channel number (#700).

Accordingly, as illustrated in FIG. 6B, the control unit 170 may display the content video 670 corresponding to the selected content item 610 on the display unit 180.

In addition, the control unit 170 may further display a virtual channel indicator 650 on the display unit 180 to indicate that the content video 670 currently being viewed is a video provided through the virtual channel.

In addition, the virtual channel indicator 650 may indicate that the virtual channel corresponds to the content item to which the user subscribes.

As described above, the user may assign a virtual channel number to a content item to which the user subscribes to view a content video quickly and easily, merely by inputting the virtual channel number.

Accordingly, the user experience may be improved.

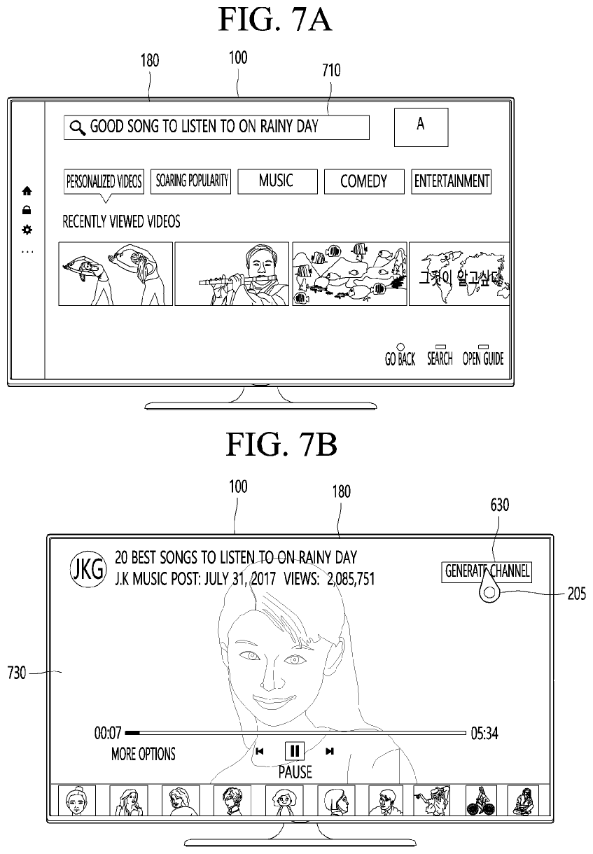

FIG. 7A to 7C illustrate a procedure of generating a content item found by a user through a virtual channel according to an embodiment of the present disclosure.

Referring to FIG. 7A, the display unit 180 displays a content search screen provided by the content provider A.

The content search screen may include a content search window 710.

The control unit 170 may search for a content item based on a text input through the content search window 710.

Thereafter, as illustrated in FIG. 7B, the control unit 170 may play the content video 730 corresponding to the content item selected by the user on the display unit 180.

The virtual channel generating button 630 may be further displayed on the display unit 180.

The control unit 170 may generate a virtual channel number (#900) corresponding to the content video 730 in response to a request for selecting the virtual channel generating button 630 through the pointer 205.

The control unit 170 may match the generated virtual channel number 900 with an access address corresponding to the content video 730 and store the matching result in the storage unit 140.

Subsequently, as the control unit 170 receives the request for selecting the virtual channel number 900, the control unit 170 may access the access address corresponding to the virtual channel number 900, as illustrated in FIG. 7C, and display the content video 730 on the display unit 180.

In addition, a virtual channel indicator 750 may be displayed on the display unit 180 to indicate that the currently viewed content video 750 is a video provided through a virtual channel.

The virtual channel indicator 750 may indicate that the virtual channel corresponds to the content item found by the search of the user.

The display unit 180 may further display a search icon 770. The search icon 770 may be an icon for searching for content associated with the content video 730 during reproduction of the content video 730 through the virtual channel.

When a request for selecting the search icon 770 is received, the control unit 170 may display a search input window on the display unit 180.

While viewing the content video 730 of the virtual channel, the user may search for an additional content video, and may add the found content video to the virtual channel.

As described above, according to an embodiment of the present disclosure, the user may generate a content video, which is found by the search of the user, through a virtual channel dedicated for the user. Accordingly, the user may easily access a desired content video merely by inputting the virtual channel number.

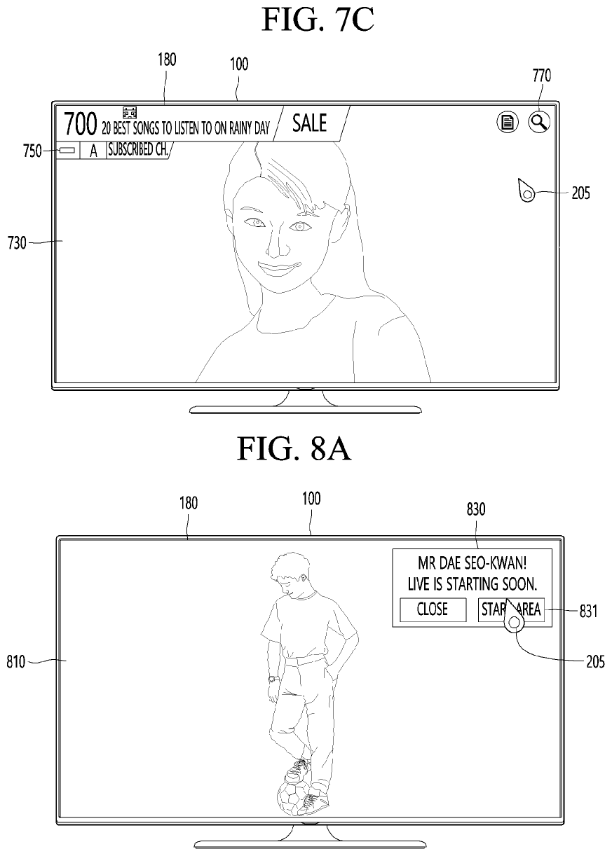

FIGS. 8A to 8B illustrate a viewing reservation function for content provided through a virtual channel according to an embodiment of the present disclosure.

Referring to FIG. 8A, the control unit 170 displays a broadcast video 810 corresponding to the general channel number on the display unit 180.

The control unit 170 may display a viewing reservation popup window 830 on the display unit 180 to set a viewing reservation when a live content video registered with a virtual channel is scheduled to be reproduced after a predetermined time.

The virtual channel number and the name of the content video corresponding to the virtual channel number may be included in the EPG information. In other words, when a virtual channel is generated, the control unit 170 may insert a virtual channel number and a content video corresponding to the virtual channel number into the EPG information.

In addition, when the content video is a live video that is temporarily broadcasted, the control unit 170 may additionally insert a broadcast time of the corresponding content video into the EPG information.

In particular, in the case of a content video having a broadcast time, which is set, the control unit 170 may display the viewing reservation popup window 830 for viewing reservation as illustrated in FIG. 8A, by using a broadcasting time included in the EPG information before the broadcast time comes.

Meanwhile, as the control unit 170 receives a request for selecting a viewing reservation button 831 included in the viewing reservation popup window 830 through the pointer 205, the control unit 170 may set a viewing reservation function for the temporarily broadcasted live content video.

Thereafter, when the corresponding broadcast time comes depending on the setting of the viewing reservation function during the reproduction of the broadcast video 810, the control unit 170 may reproduce, on the display unit 180, the live content video 850, which is temporarily broadcasted, as illustrated in FIG. 8B.

To this end, the control unit 170 may automatically select a virtual channel number corresponding to the live content video 850. In other words, the control unit 170 may switch the broadcast video 810 into the content video 850 by changing the channel.

The control unit 170 may further display a virtual channel indicator 870 indicating that the live content video 850 currently being viewed is a temporary content video while reproducing the live content video 850.

In addition, the virtual channel indicator may indicate that the live content video 850 currently being viewed is a video provided through the virtual channel.

When the reproduction of the live content video 850 is finished, the control unit 170 may display, on the display unit 180, a pop-up window 870 for inquiring about moving to a previous viewing channel.

As described above, the user may quickly view a content video which is temporarily broadcasted and corresponds to a content item to which the user subscribes, without a complex procedure.

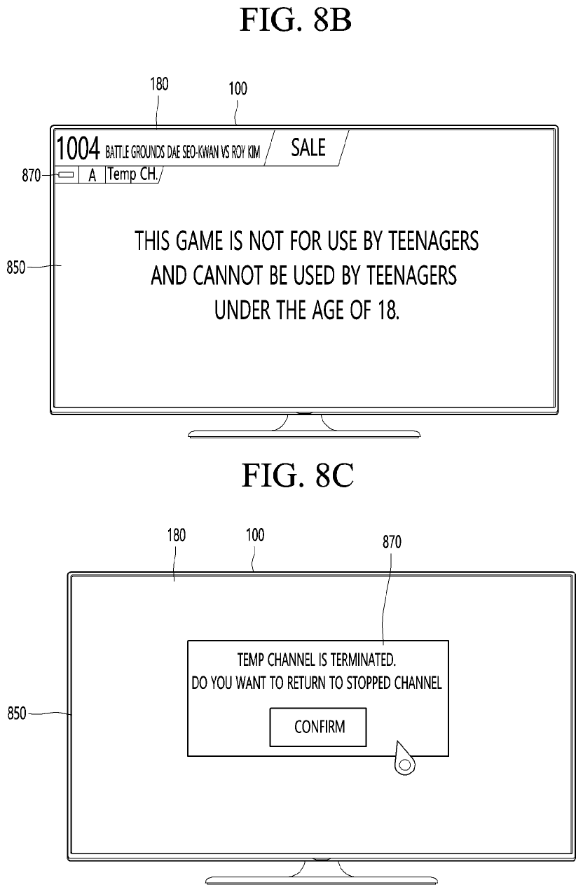

FIG. 9 illustrates a channel table according to an embodiment of the present disclosure.

A channel table 900 may be used to determine whether the channel number selected by the user is a general channel number, a virtual channel, or a prohibited channel.

The channel table 900 may be a table corresponding to a channel number, a channel type, and an identifier. The channel table 900 may be included in the EPG information and stored in the storage unit 140.

The channel number represents a number.

The channel type may be a type for identifying whether the corresponding channel is a general channel, a virtual channel, or a prohibited channel.

The identifier may be an identifier of content corresponding to the channel number.

For example, when a channel has a channel number of ‘1’ and is the general channel, a program identifier for identifying a broadcast program may be matched with the channel number and stored.

When a channel has a channel number of ‘700’ and is the virtual channel, an access address (URL) for access to the content provider may be matched with the channel number and stored.

When a channel has a channel number of ‘2000’ and is the prohibited channel, a prohibited channel identifier for identifying that the channel number is the prohibited channel number may be matched with the channel number and stored.

When the channel number in a general channel type is selected, the control unit 170 may determine that the corresponding channel number is the general channel number using the program identifier of the channel table 900.

When the channel number in a virtual channel type is selected, the control unit 170 may determine that the corresponding channel number is the virtual channel number using the access address to the channel table 900.

When the channel number in a prohibited channel type is selected, the control unit 170 may determine that the corresponding channel number is the prohibited channel number using the prohibited channel identifier.

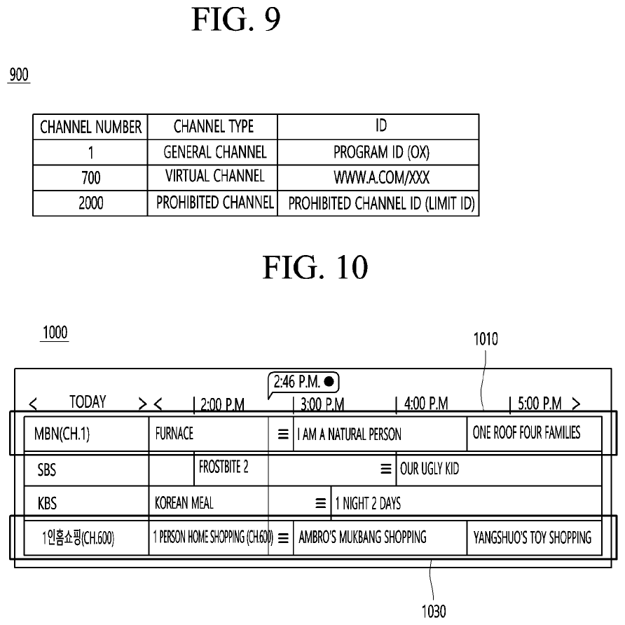

FIG. 10 illustrates information on a virtual channel which is included in an electronic program guide according to an embodiment of the present invention.

Referring to FIG. 10, an electronic program guide 1000 may include a general channel item 1010 and a virtual channel item 1030.

The general channel item 1010 may include names of broadcast programs to be sequentially broadcasted through a channel of the general channel number.

The virtual channel item 1030 may include names of content videos to be sequentially broadcasted through a channel of the virtual channel number.

When the virtual channel is generated, the control unit 170 may insert the virtual channel number, the name of the content video corresponding to the virtual channel number, and the broadcasting time of the content video into the electronic program guide.

Within the electronic program guide, the information on the virtual channel and the information on the general channel may be marked while being distinguished from each other. For example, the information on the virtual channel and the information on the general channel may be distinguished from each other through symbols, colors, highlights, and texts.

The user may recognize information on the content provided through the virtual channel generated by the user in addition to the general channel at a glance using the electronic program guide. Accordingly, the user experience may be maximized.

According to an embodiment of the present disclosure, the above method may be implemented in the form of a computer-readable code in a media having a program. For example, the computer-readable recording medium may be a read-only memory (ROM), a random-access memory (RAM), a compact disk read-only memory (CD-ROM), a magnetic tape, a floppy disk, an optical data storage device, and the like. Also, the recording medium may be implemented in the form of carrier waves, (e.g., transmission over the Internet).

Accordingly, the above-described display device should not be limitedly interpreted, but be considered only for the illustrative purpose It is intended that the present disclosure covers all such modifications provided they come within the scope of the appended claims and their equivalents.

1. A display device comprising:
a storage unit;
a display unit;
a network interface unit to make communication with a server of a content provider to provide content; and
a control unit configured to generate a virtual channel number in response to receiving a virtual channel generating request for the content, match the generated virtual channel number with an access address of the content, and store a matching result in the storage unit.

2. The display device of claim 1, wherein the control unit is configured to:
display the content on the display unit, by using the access address in response to receiving a channel selecting request to select the virtual channel number.

3. The display device of claim 2, wherein the control unit is configured to:
further display, on the display unit, a virtual channel indicator to indicate that the content is provided through a virtual channel.

4. The display device of claim 3, wherein the virtual channel indicator indicates whether the content is content to which a user subscribes, content found by search of the user, or live content that is temporarily broadcasted.

5. The display device of claim 1, further comprising:
a tuner to receive a broadcast video,
wherein the control unit is configured to:
display, on the display unit, a pop-up window to set a viewing reservation function for the content while the broadcast video is reproduced.

6. The display device of claim 5, wherein the control unit is configured to:
change the broadcast video to the content through channel change when the viewing reservation function is set, and a broadcasting time of the content comes.

7. The display device of claim 1, wherein the control unit is configured to:
determine a channel type of a channel number, in response to receiving a request for selecting the channel number; and
determine whether the selected channel number is a general channel number, the virtual channel number, or a prohibited channel number, based on the channel type.

8. The display device of claim 7, wherein the control unit is configured to:
determine the channel type using a program identifier to identify the general channel number, an access address to identify the virtual channel number, and a prohibited channel identifier to identify the prohibited channel number.

9. The display device of claim 8, wherein the control unit is configured to:
display, on the display unit, a broadcast video corresponding to the general channel number, when the channel number is the general channel number.

10. The display device of claim 8, wherein the content is displayed on the display unit by accessing the server of the content provider through the access address, when the channel number is the virtual channel number.

11. The display device of claim 8, wherein the control unit is configured to:
display a black screen or notifies a prohibited channel, when the channel number is the prohibited channel number.

12. The display device of claim 1, wherein the display unit further displays:
a virtual channel generating button to generate the content or a virtual channel for the content, and
wherein the control unit is configured to:
generate the virtual channel number in response to selecting the virtual channel generating button.

13. The display device of claim 1, wherein the storage unit sores matching among the virtual channel number, a type of a virtual type, and an access address to identify the virtual channel.

14. The display device of claim 1, wherein the virtual channel number and a name of the content are included in an electronic program guide.

15. The display device of claim 14, wherein information on a virtual channel and information on a general channel are marked in the electronic program guide while being distinguished from each other.
